(19) United States
(12) Patent Application Publication
(10) Pub. No.: US 2019/0315083 A1
(43) Pub. Date: Oct. 17, 2019

(54) METHOD FOR PRODUCING A SPORTS GLOVE, PARTICULARLY A GOALKEEPER'S GLOVE

(71) Applicant: PUMA SE, Herzogenaurach (DE)

(72) Inventors: Matthias HARTMANN, Forchheim (DE); Fabien GHIOTTI, Nürnberg (DE)

(21) Appl. No.: 15/735,125

(22) PCT Filed: Aug. 13, 2015
(86) PCT No.: PCT/EP2015/001668

§ 371 Date: Dec. 8, 2017

(51) Int. Cl. B29D 99/00; A41D 19/04; A41D 19/015; A63B 71/14

(52) U.S. Cl. CPC B29D 99/0067; A41D 19/04; A41D 19/01523; B29K 2075/00; A63B 2209/00; A63B 2243/0025; A63B 71/148

(57) ABSTRACT

A method for the production of a sports glove, especially of a goal keeper's glove. To improve the wearing comfort of the sports glove the method provides the steps: a) Providing of a laminar carrier substrate; b) Deposition of a plurality of discreet material sections of a foamed plastic material onto at least one side of the carrier substrate; c) Production of at least a section of the sports glove by use of the carrier substrate with the material sections produced according to step b).

The invention relates to a method for the production of a sports glove, especially of a goal keeper's glove.

It is a requirement for sports gloves, especially for goal keeper's gloves, that during use a sufficient wearing comfort is given, which can be obtained at the use especially by a certain inner venting of the glove. It is a further aspect especially at the use of the glove for soccer sports that a well pressure distribution takes place at the contact of the goal keeper's glove with the ball which delivers a gentle effect for the hand especially at fisting of ball.

Indeed, special manufactured sports gloves allow for the above desired but require to a high degree manufacturing efforts and handcraft respectively which makes the glove expensive with respect to the manufacturing.

From DE 200 05 619 U1 a sports glove is known which is provided at its outer side with a cushion layer which comprises discreet cushion parts made of foamed material. Similar and other solution are shown in US 2012/0005805 A1 and in WO 2012/068418 A1.

It is an object of the invention to propose a production method for a glove, especially for a goal keeper's glove, by which it is possible to obtain a better wearing comfort of the glove. Furthermore a design of the glove should be obtained by which a good pressure distribution at the contact with a ball is given. Also, an essential aspect is that the production of the glove can take place in a cost-efficient manner.

The solution of this object by the invention is characterized in that the production method for the sports glove comprises the steps:

a) Providing of a laminar carrier substrate;
b) Deposition of a plurality of discreet material sections of a foamed plastic material onto both sides of the carrier substrate;
c) Production of at least a section of the sports glove by use of the carrier substrate with the material sections produced according to step b).

Thereby, the deposition of the material sections takes place preferably by rolling of an applicator roll on the carrier substrate. However, also a deposition of the material sections by hand, if applicable by means of a template, is possible.

After carrying out of above step b) and prior carrying out of above step c) a coating can be applied additionally onto the carrier substrate and the material sections. The coating material for the mentioned coating is especially paint.

Preferably, a textile material, a microfiber material or a leather material is used as laminar carrier substrate, especially such a material made from a fiber of block copolymer with the components polyurethane and polyethylene glycol (elastane) and/or of polyester.

The laminar carrier substrate can thereby have an anisotropic behaviour in two directions which are perpendicular to another with respect to its stress-strain properties. This means that the stress-strain property differ in different directions of elongation.

The material sections consist preferably of polyurethane or comprise at least this material. A further material can be mixed into the polyurethane, especially a rubber material (latex), especially natural rubber, or paraffin.

The material sections can be (at least in sections) equally distributed material dots on the surface of the carrier substrate. It is also possible to provide an unequal distribution; this can be beneficial with respect to ergonomic aspects.

The material sections have preferably the shape of spherical caps (including semi-spheres), cones and/or pyramids, especially with rhomb-shaped base.

Thereby, the material sections have preferably a height above the carrier substrate, which is between 0.5 mm and 5 mm.

The distance of the material sections is preferably between 1.0 mm and 10 mm, specifically preferred between 1.5 mm and 5 mm.

The distance of the material sections and/or their height above the surface of the carrier substrate is preferably constant. The distance of the material sections and/or their height above the surface of the carrier substrate can however be variable, so that regions of material sections with higher concentration and/or height are formed on the carrier substrate.

A further possible embodiment of the invention provides that the carrier substrate is a textile material made of polyamide (Nylon). According to another embodiment the carrier substrate can also be designed as foam layer on which then the foam dots are applied.

So the present invention is basing on the concept to provide at the production of a sports glove a carrier material—preferably made of a textile material—by means of an applicator roll with a regular or also irregular pattern especially made of polyurethane foam dots (material sections). Then, the sports glove is produced partially or also completely from the carrier material which is “printed” in such a manner.

The distribution of the material sections, thus of the “foam dots”, can thereby take place in such a manner as demanded by the ergonomics, i. e. an unequal distribution and size of the foam dots can be provided.

By the foam dots with a height preferably between 0.5 mm and 5 mm, wherein the height of the foam dots is preferably equal, the circulation of the air in the inner of the glove is beneficially facilitated as far as the foam dots are arranged in the inner of the glove. If they are arranged at the outer side of the sports glove especially during use for soccer an improved pressure distribution between the glove and the ball can be obtained.

The foam dots can be designed spherical segment shaped, cone shaped or pyramid shaped (rhomb shaped).

The carrier material consists preferably from an elastane polyester mixture; it can be anisotropic with respect to its stress-strain properties.

It can also be provided that the foam dots are provided at the outside with a thin layer, especially of paint.

The foam dots comprise as the main component polyurethane, however also other admixtures can be provided, like latex or paraffin.

The present invention relates generally to the production of a glove. However, the described manufacturing concept can also be beneficially used for other applications.

In the drawing an embodiment of the invention is depicted. It shows:

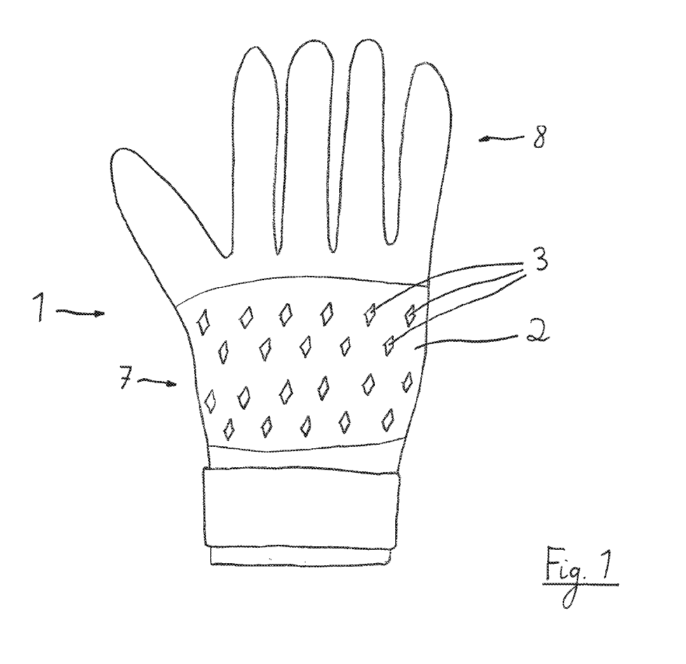

FIG. 1 in the front view a goal keeper's glove according to the invention,

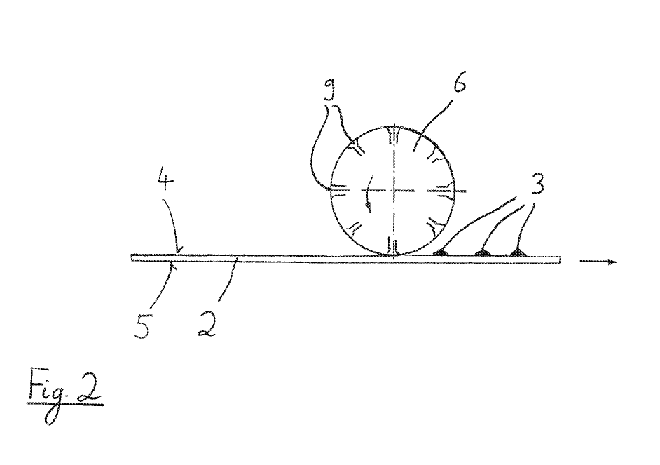

FIG. 2 in the side view a textile carrier material from which a part of the goal keeper's glove is manufactured, wherein the carrier material is provided by means of an applicator roll with material sections in the form of foam dots, and

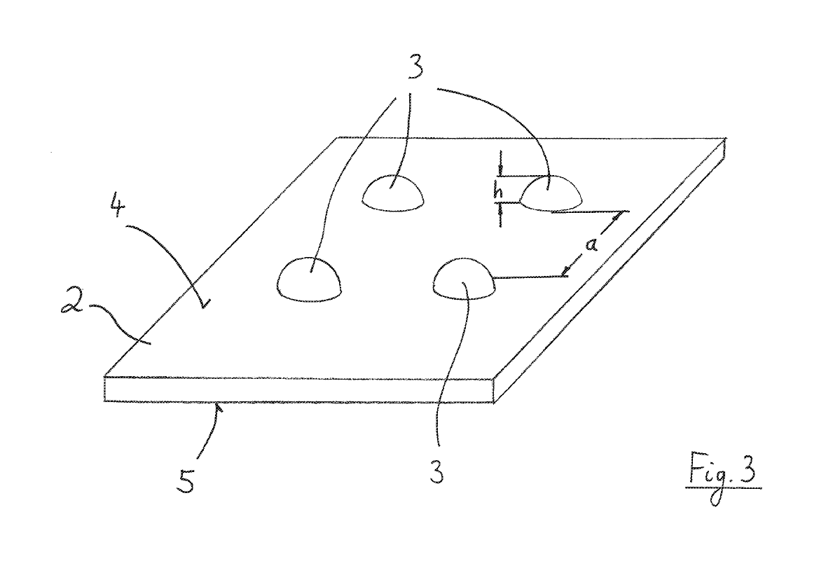

FIG. 3 the carrier material with material sections from which the goal keeper's glove is produced.

In FIG. 1 a sports glove 1 being a goal keeper's glove is shown which comprises two sections 7 and 8, namely the region of the back of the hand 7 and the region of the finger 8. During the production of the section 7 presently a material is used which comprises of a laminar carrier substrate 2 on which material sections 3 are applied; those material sections 3 are designed as foam dots.

The production of the carrier substrate 2 and the application of the material sections 3 is shown in FIG. 2—however only very schematically.

In the shown embodiment the laminar carrier substrate 2 is provided at its upper side 4 with material sections 3, while the bottom side 5 of the carrier substrate 2 remains here free from material sections 3.

For the deposition of the material sections 3 an applicator roll 6 is used. Here foamed polyurethane material is guided via inner supply pipes to output nozzles 9; at rolling of the applicator roll 6 on the laminar carrier substrate 2 a respective amount of polyurethane foam is applied onto the carrier substrate 2 so that the material sections 3 are deposited in the form of foam dots at the upper side 4 of the carrier substrate 2.

The result which is obtained hereby is shown schematically in FIG. 3. As can be seen material sections 3 in the form of foam dots are deposited on the carrier substrate 2. In the embodiment a uniform coverage of the carrier substrate 2 with material sections 3 is given, wherein the material sections 3 are here designed semi-spherical shaped.

Just as well of course other shapes can be taken in consideration, for example pyramid-shaped designs with a rhomb-shaped basis.

It can be seen in FIG. 3 that the structure of the material sections are characterized by a distance a between the single foam dots as well as by a height h of the foam dots. The distance a as well as the height h are chosen in such a manner that the desired effect is obtained. Specifically proven values for the distance are 2 mm to 6 mm and for the height 1 mm to 4 mm.

Thereby, it can be reasonable to provide in certain regions of the carrier substrate 2 a higher density of foam dots as at other locations to create in a respective region of the glove more or less influence of the foam dots.

As can be seen in FIG. 1 the sports glove 1 is only partial and sectional respectively manufactured from the carrier material 2 which is coated with the foam dots.

However, it is also possible to produce the whole sports glove 1 from said material.

### LIST OF REFERENCES

1 Sports glove (Goal keeper's glove)
2 Laminar carrier substrate
3 Material section (foam dot)
4 Side of the carrier substrate
5 Side of the carrier substrate
6 Applicator roll
7 Section (region of the back of the hand)
8 Section (region of the finger)
9 Output nozzle
h Height of the material sections
a Distance of the material sections

1. A method for the production of a sports glove, especially of a goal keeper's glove, wherein it comprises the steps:
a) Providing of a laminar carrier substrate;
b) Deposition of a plurality of discreet material sections of a foamed plastic material onto both sides of the carrier substrate;
c) Production of at least a section of the sports glove by use of the carrier substrate with the material sections produced according to step b).

2. The method according to claim 1, wherein the deposition of the material sections takes place by rolling of an applicator roll on the carrier substrate.

3. The method according to claim 1, wherein after carrying out of step b) and prior carrying out of step c) a coating is applied onto the carrier substrate and the material sections, wherein the coating material is preferably paint.

4. The method according to claim 1, wherein a textile material, a microfiber material or a leather material is used as laminar carrier substrate, especially such a material made from a fiber of block copolymer with the components polyurethane and polyethylene glycol (elastane) and/or of polyester.

5. The method according to claim 1, wherein the laminar carrier substrate has an anisotropic behaviour in two directions which are perpendicular to another with respect to its stress-strain properties.

6. The method according to claim 1, wherein the material sections consist of polyurethane or comprise this material.

7. The method according to claim 6, wherein a further material is mixed into the polyurethane, especially a rubber material, especially natural rubber, or paraffin.

8. The method according to claim 1, wherein the material sections are at least in sections equally distributed material dots on the surface of the carrier substrate.

9. The method according to claim 1, wherein the material sections have the shape of spherical caps, cones and/or pyramids, especially with rhomb-shaped base.

10. The method according to claim 1, wherein the material sections have a height above the carrier substrate, which is between 0.5 mm and 5 mm.

11. The method according to claim 1, wherein the distance of the material sections is between 1.0 mm and 10 mm, preferably between 1.5 mm and 5 mm.

12. The method according to claim 1, wherein the distance of the material sections and/or their height above the surface of the carrier substrate is constant.

13. The method according to claim 1, wherein the distance of the material sections and/or their height above the surface of the carrier substrate is variable, so that regions of material sections with higher concentration and/or height are formed on the carrier substrate.
